(19) United States
(12) Patent Application Publication
(10) Pub. No.: US 2012/0047437 A1
(43) Pub. Date: Feb. 23, 2012

(54) Method for Creating and Navigating Link Based Multimedia

(76) Inventor: Jeffrey Chan, Henderson, NV (US)

(21) Appl. No.: 12/906,072

(22) Filed: Oct. 15, 2010

Related U.S. Application Data
(60) Provisional application No. 61/375,897, filed on Aug. 23, 2010.

(51) Int. Cl. G06F 3/048

(52) U.S. Cl. 715/720

(57) ABSTRACT

A method, in combination with or on a computer, for defining, editing, and jumping to predefined points in time in audio, video and other multimedia playback by selecting a point of interest from a scrolling list of choices, rendered with dynamic transparency if superimposed on motion graphics or video. Additionally, the present invention renders such a system to be easily used on a small screen while maximizing viewable area, as well as on large screen devices with various devices or human input.

### CONTINUITY DATA

The present invention is a non-provisional application of provisional patent application No. 61/375,897 filed on Aug. 23, 2010, and priority is claimed thereto.

### FIELD OF THE PRESENT INVENTION

The present invention is a method for defining, editing, and jumping to predefined points in time in audio, video and other multimedia playback on a computer device by selecting a point of interest from a scrolling list of choices, rendered with dynamic transparency if superimposed on motion graphics or video. Additionally, the present invention renders such a system to be easily used on a small screen while maximizing viewable area, as well as on large screen devices with various device and human input.

The present invention relates generally to enhancing multimedia based entertainment, educational/instructional videos, and dynamically generated animation detailing a sequence of events on a computer device, particularly material for which it is beneficial to be able to instantly recall or preview information, by providing a system that displays and optionally overlays a plurality of text and graphical elements in a variable transparency layer over the primary visual content.

### BACKGROUND OF THE PRESENT INVENTION

The present invention provides a method for rapidly creating audio, video, and animation on a computer device that gives a user the ability to rapidly and accurately navigate to specific points in the media, above and beyond the level of accuracy found in currently available methods.

Traditionally, a viewer listening to audio or watching a video program experienced the multimedia product in a linear fashion. With the invention of CDs, DVDs, and Digital Video files, however, users could jump to particular chapter marks defined by the content creator. A CD recording can have a track for each song, and a DVD can have a chapter for each scene in a movie. However, the ability to jump back and forth to a particular sentence or phrase of sung or spoken dialogue has not yet been possible. A user listening to an digitized audio recording or watching a movie can “rewind,” or repeat a chapter, but doing so often goes too far back, and forces a user to again spend time watching and/or listening to a portion of media he or she is not interested in. Even more so, when comprehending spoken language is of utmost importance, such as for language learners, being able to simply access a specific sentence or two is highly problematic. In recent digital media, we have seen some level or effort to remedy this problem in the “jump back 30 second” function. This however is often still too big a jump, and often takes the user to a point of little interest. In short, this style of jump is arbitrary and entirely ignores linguistic and content context.

Video players showing subtitles often only display text in one language, and often the subtitle would be removed from the screen too quickly for complete comprehension. This is especially problematic for second language learners who must choose between hearing native speech and being unable to read the foreign subtitles quickly enough, or hearing foreign speech and having no foreign subtitles to verify their listening comprehension against. Furthermore, entertainment devices such as karaoke machines display either one phrase at a time, or multiple phrases which are displayed and cleared as a single unit. This makes practicing a song difficult because a user can lose visibility of the lyrics too soon. Add this to the inability to rewind just a single phrase, and entertainment becomes a frustrating experience.

In the realm of language learning, having a visual representation of audio, or audio soundtrack of a video is often a way to enhance comprehension. However, lyrics for audio are only found in music videos or karaoke playback. Since these products are based on traditional CD and DVD technology, they can be navigated no better than can a typical CD or DVD player. Computer-based audio and video players often allow users to “scrub” the audio or video by dragging a time slider. However, even small movements of the time slider, even as little as a few pixels, often result in time jumps of 6 to 10 seconds at a minimum. Even worse, the longer the media playback time, the coarser the controls because a greater time range would be assigned the same resolution scrubber. For example, for a 2 minute movie, a 120 pixel wide scrubber would have a resolution of 1 second per pixel. On the other hand, for a 2 hour movie, every pixel movement of a scrubber would result in a 1 minute jump. These large jumps in time can be referred to as low scrubbing resolution. Ideally, users should be able to scrub with sub-second accuracy, which would be high scrubbing resolution.

Language education companies have recently begun releasing programs that run on a standard computer, such as a home computer or laptop that display a separate window alongside the video program (in essence providing two virtual monitors, one for the spoken transcript, and one for the video). In the spoken transcript window, certain words are highlighted that are clickable for more information. However, most often the user does not have any ability to arbitrarily scroll both forwards and backwards in transcript without limit. Thus the user is required to linearly experience content

In the realm of global positioning system (GPS) navigation systems used during vehicle or pedestrian routing, the navigation instructions are likewise rendered in a linear fashion, progressing as the user navigates according to the prescribed path. In these navigation systems, typical waypoint listings require a dedicated screen. For example, while viewing a display of a vehicle on a map, if a user wanted to preview all the steps necessary to navigate to the destination, the map would typically be obscured by a full screen display listing each navigation instruction (a typical instruction being, for example, “Take a left turn at 5^{th} Avenue”). These navigation instructions are analogous to the track marks in a CD, or chapter marks in a DVD.

In a recent GPS navigation program, an attempt to provide more detail employed an overlay of a semi-transparent listing of instructions on the right third of the map display. A user could scroll this listing up and down, and turn the semi-transparent listing on and off in a binary fashion. However, the semi-transparent listing was not designed to automatically disappear or vary in transparency, resulting in the listing always obscuring roughly one-third of the available screen space, or screen real estate. This posed a danger of distracting a driver because it required physical interaction with the GPS device to deactivate the listing. Physical interaction with the GPS device, much like texting while driving, is dangerous, and this type of well-meaning feature could raise the risk of automobile collision. Traditional GPS navigation devices also suffered from the deficiency of implementing the navigation instructions as a single long vertical list of data, much as with audio lyric displays. Even though the list could be scrolled up and down like lyrics, the user was unable to click or select a specific instruction from the semi-transparent overlay list. Furthermore, if a user wanted to review previous navigation instructions, “old” navigation instructions were not accessible. Users who wanted to filter out minor instructions to focus on “highways only” or vice versa were not able to do so, and were always at risk of being distracted by “extra” information. In short, the navigation instruction listing on traditional GPS devices is merely a listing that, even with user interaction, neither loads and displays additional data, nor alters the content of the underlying graphical animation.

Additionally, synchronizing subtitles with media has traditionally been a tedious process. Typically an interface is provided to enable playback of the video media. The user types the start and end time related to a particular subtitle, and enters the subtitle text. Alternatively, the user may select from a time slider the start and end time of the subtitling. The problem is that typing times into a form field is tedious and time consuming. The alternative, which is clicking and dragging a time slider, is inaccurate because the scrubbing resolution is so low. This leads to large labor inefficiencies, increasing the cost of producing multimedia goods. With an innovative solution, production costs could be reduced significantly.

U.S. Pat. No. 6,076,059, issued to Glickman et al. on Jun. 13, 2000, is a computerized method of aligning text segments of a text file with audio segments of an audio file. U.S. Pat. No. 6,442,518, issued to Van Thong et al. on Aug. 27, 2002, is a method for refining time alignments on closed captions. U.S. Pat. No. 7,787,753 issued to Kim et al. on Aug. 31, 2010; stores a text subtitle stream and related data. However, unlike the present invention, Glickman et al., Van Thong et al., and Kim et al. do not allow a user to have granular control of individual text segments.

Therefore, despite the innovations in this area, there is a need for a method of quickly creating entertainment and educational media enabled with rapid accurate navigation, down to the spoken phrase or sentence level, on a computer device.

### SUMMARY OF THE INVENTION

The present invention provides a method for rapidly creating audio, video, and animation that gives a user the ability to rapidly and accurately navigate to specific points in the media, above and beyond the level of accuracy found in currently available methods, on a computer device. When the present invention is in use, multiple subtitles or navigation elements are simultaneously visible in a scrollable layer. Each subtitle is associated with a point in time in the audio, video, or navigation path, allowing users to select a sentence, phrase, or navigation element they wish to jump to and preview or review. Also, users may scroll the subtitles to find a phrase, sentence, or navigation guide that may not currently be visible onscreen. Where scrolling is inefficient, a search function is provided. Content creators and publishers enhancing content will additionally find the present invention useful because it allows rapid timing of subtitles by importing text and graphics which either A) do not contain timing, or B) have incorrect timing, and then touching or selecting the subtitle that is currently being played without sacrificing screen real estate. The present invention adds navigation creation, playback, and scrubbing functionality without requiring a larger display surface.

Audio players that display lyrics for songs rarely have the functionality to synchronize displayed lyrics with audio playback position. Specialized technology, however, is available to enhance the experience by utilizing additional data to synchronize display of lyrics with the audio playback. With less advanced technology, lyrics can be scrolled, but would not be automatically synchronized to the audio playback. In more advanced configurations, lyrics display is synchronized, but could not be manually scrolled other than by dragging the “time-slider” to change the playback position based on the playback time. User interaction with just a phrase was impossible because displayed lyrics are “read-only,” and all lyrics would be rendered as a “single element” containing all the lyrics. Granted, in some cases, the active lyrics would be visually emphasized in some way, but again that is a “read-only” emphasis. Thus there was no way to interact with a phrase. The present invention, however, individually accounts for each lyric element. To make an analogy, the present invention presents lyric elements as “individually wrapped slices” rather than as a “single block of cheese.” With the present invention, a user can search for content of interest, scroll to verify content the user wishes to jump to, and jump directly to the desired point based on lyrics, subject, and so forth.

A user interface layout, in which a full scrolling transcript of audio is displayed in a second window separately from the video, consumes large amounts of screen real estate. This makes it impractical for small handheld devices, therefore limiting its use to large screen devices. The traditional solution is to superimpose the subtitles on the video with alpha blending, a method of making the text semi-transparent. This causes its own issues because such subtitling is, by definition, only on the lower part of the screen in order to prevent obscuring the video image. However, since speech is often rapid, as each spoken phrase quickly passes by in time, the visual subtitle disappears too quickly. The typical display duration of a subtitle is too short for a student to comprehend either the foreign spoken word, or to read the foreign subtitle. This is even a problem for native English speakers watching a Chinese language action movie with rapidly appearing and disappearing English subtitles. Again, skipping back to a certain point, for example two sentences back, is for all intents and purposes not feasible.

Additionally, synchronizing subtitles with media has traditionally been a tedious process. Typically an interface is provided to enable playback of the video media. The user types the start and end time related to a particular subtitle, and enters the subtitle text. Alternatively, the user may select from a time slider the start and end time of the subtitling. The problem is that typing times into a form field is tedious and time consuming. The alternative, which is clicking and dragging a time slider, is inaccurate because the scrubbing resolution is so low. This leads to large labor inefficiencies, increasing the cost of producing multimedia goods. With an innovative solution, production costs could be reduced significantly.

### BRIEF DESCRIPTION OF THE FIGURES

FIG. 1a shows a typical embodiment of the present invention's layout in media overlay partial screen mode.

FIG. 1b shows a typical embodiment of the present invention's layout in media overlay full screen mode.

FIG. 2a shows a typical embodiment of the present invention's layout in portrait mode.

FIG. 2b shows a typical embodiment of the present invention's layout in portrait mode with full screen media jump overlay.

FIG. 2c shows a typical embodiment of the present invention's layout in large screen mode.

FIG. 3a shows how the media jump overlay is synchronized with media playback and even during scrubbing.

FIG. 3b shows how the media jump overlay is synchronized with various positions.

FIG. 3c shows the media jump overlay is synchronized for navigation.

FIG. 4 shows how the media jump overlay alpha is adjusted depending on the amount and type of user interaction with the media jump overlay.

FIG. 5 shows how the media jump overlay can scroll due to user interaction.

FIG. 6 shows how the media jump overlay renders media jump links based on media jump link data.

FIG. 7 shows how tapping or clicking a media jump link element can cause the playback position of media to change.

FIG. 8a shows how the media jump overlay renders media jump links based on media jump link data.

FIG. 8b shows how the media jump overlay responds to a hold interaction with a particular media jump link based on a user's role.

FIG. 8c shows how the media jump overlay responds to a swipe interaction with a particular media jump link based on a user's role.

FIG. 9 shows how the present invention can retrieve data from local storage or the network and send administrative metadata transfers back over the network.

FIG. 10 shows an example of how data can be formatted to enable media jump links to jump to a time associated with a media.

FIG. 11 shows information retrieved via local storage or via the network and rendered on screen.

FIG. 12a shows how the search function enables quick navigation to media jump links of interest.

FIG. 12b shows how the search function reacts to various interactions with a media jump link.

### DETAILED DESCRIPTION OF THE PRESENT INVENTION

The present invention is a method, in combination with a computer device, for defining, editing, and jumping to predefined points in time in audio, video and other multimedia playback by selecting a point of interest from a scrolling list of choices. These choices are presented to the user in the form of media jump links (100) and media jump overlays (102). The media jump overlay (102) is a scrolling layer or window containing one or more media jump links (100), typically containing text elements representing lyrics or subtitles, and optionally graphic elements. A media jump link (100) is a repository comprising one or more visual elements such as text, graphics, and animation, to include visible audio lyrics, visible audio transcripts of video media, visible text, and visible graphics. A media jump link (100) can actually contain text in one or more fonts, text in one or more languages, graphics, animation—basically anything visual. To this end, a media jump link (100) also comprises elements unseen to the user, including timing information, language designation, dialect designation, emotion, tone of voice, subject matter, arbitrary character string tags, active speaker, active listener, element active start time, element active end time, network media links such as web pages and data sources, longitude, latitude and so forth.

The media jump overlay (102) contains multiple entries or media jump links (100) containing text elements, these text elements typically segmented by sentence and optionally by phrase for longer sentences. In navigation devices such as GPS systems, each significant navigation instruction is segmented. Each sentence, phrase or segment is termed a media jump link (100). Multiple media jump links (100) are displayed on the media jump overlay (102). Media jump links (100) may be configured to simultaneously display in more than one language. Media jump links (100) may also be rendered differently depending on the speaker, emphasis, subject matter, or tone of voice.

The present invention can be viewed on a standard computer monitor, a conventional television screen, a handheld device such as an iPhone™, or other devices that provide audio, video, and other multimedia playback. It may be viewed in landscape mode or in portrait mode. The media being played back can include media such as computer-generated or pre-recorded audio and video such as navigation, animation, and karaoke style compact disc plus graphics (CD+G) text that colors in letters in a word as they are sung. In addition, where sufficient screen real estate is available, the media jump overlay (102) may be displayed in a dedicated area beside the rendered graphical display of the media playback. In some cases, the user may desire to view the media jump overlay (102) in a full screen mode without showing media player controls. This is often the case because media player controls take up too much screen real estate in relation to the functionality offered.

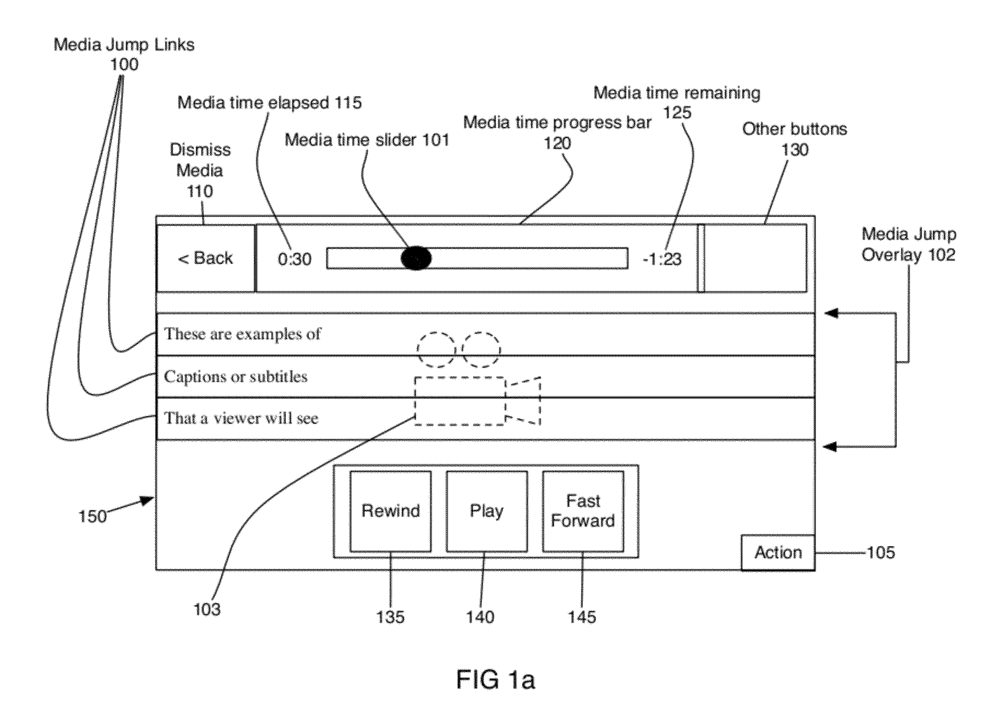

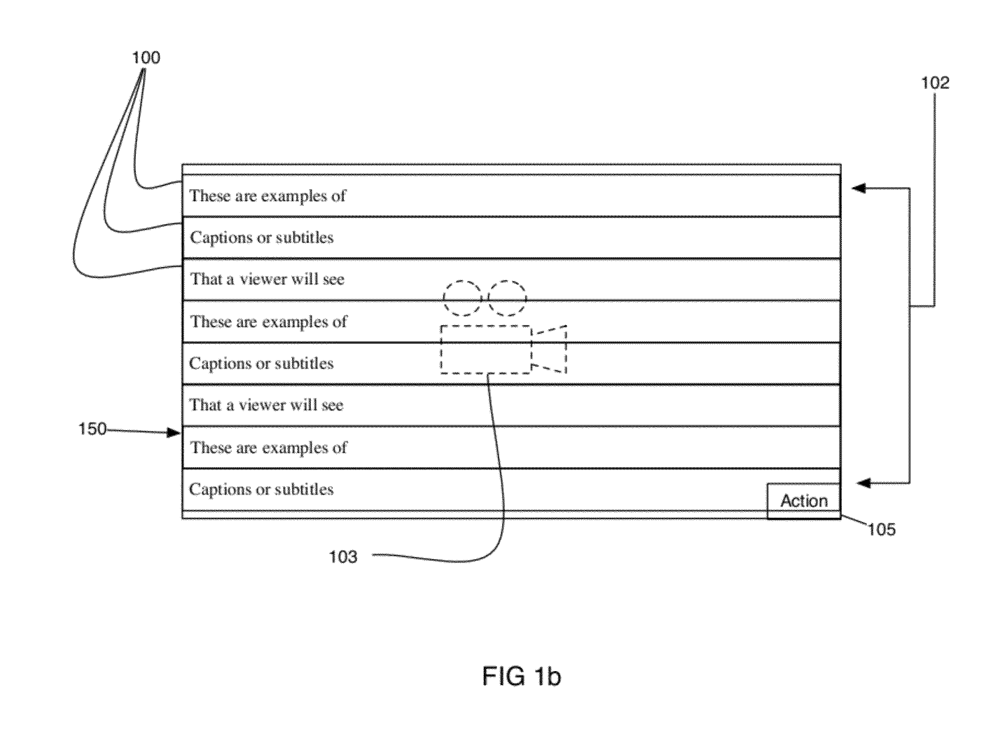

FIG. 1a shows a typical embodiment of the present invention's layout in landscape mode and media overlay partial screen mode. Three media jump links (100) are shown within the media jump overlay (102). The media jump links (100) within the media jump overlay (102) visually occupy the same space, or “overlay” the full motion media (103) displayed on the screen (150) of the conventional electronic device. The media player controls can be seen on both the top and bottom of the screen (150). On the top of the screen (150), there is a dismiss media button (110) by which the user can suspend the use of (i.e., close) the present invention, a media time progress bar (120) with a media time elapsed indicator (115), a media time slider (101), and a media time remaining indicator (125), and an option button (130). At the base of the screen are standard media controls, namely rewind (135), play (140), and fast forward (145). Also shown is an action button (105) that is also designed to present a menu from which program options can be configured, such as media selection, playback modes, visual preferences, and so forth.

FIG. 1b shows a typical embodiment of the present invention's layout in landscape mode with media overlay in full screen mode. Eight media jump links (100) are shown within the media jump overlay (102). The media jump links (100) within the media jump overlay (102) visually occupy the same space, or “overlay” the full motion media (103) displayed on the screen (150) of the conventional electronic device. No media player controls are shown in FIG. 1b, excepting the action button (105) at the bottom of the screen (150). The action button (105) brings up a menu from which program options can be configured, such as toggling media jump overlay (102) between partial and full screen mode, media selection, playback modes, visual preferences, and so forth.

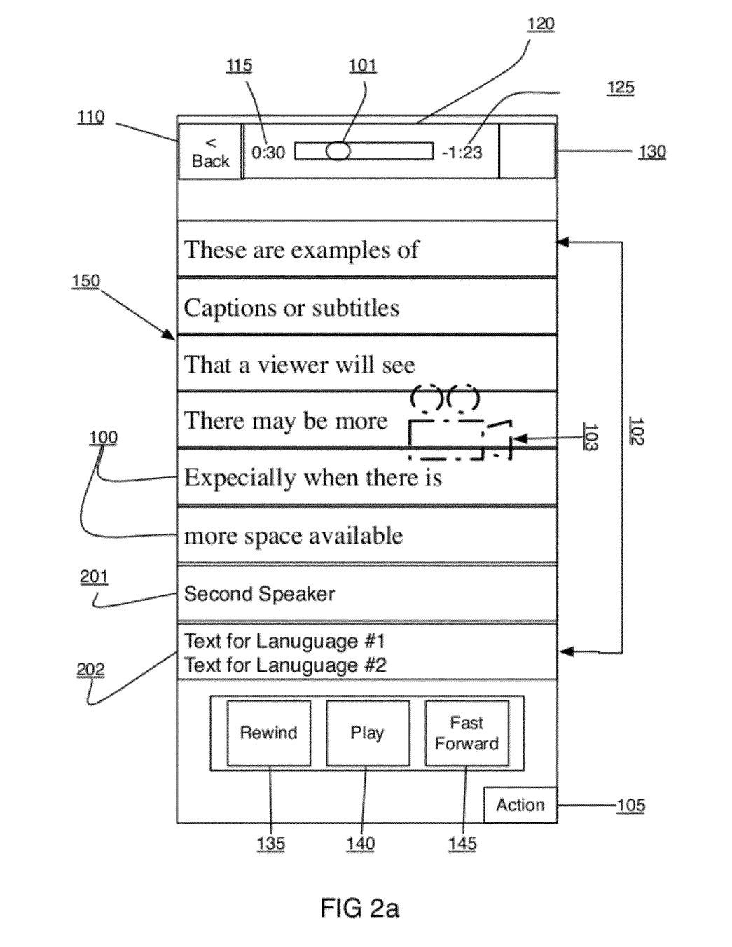

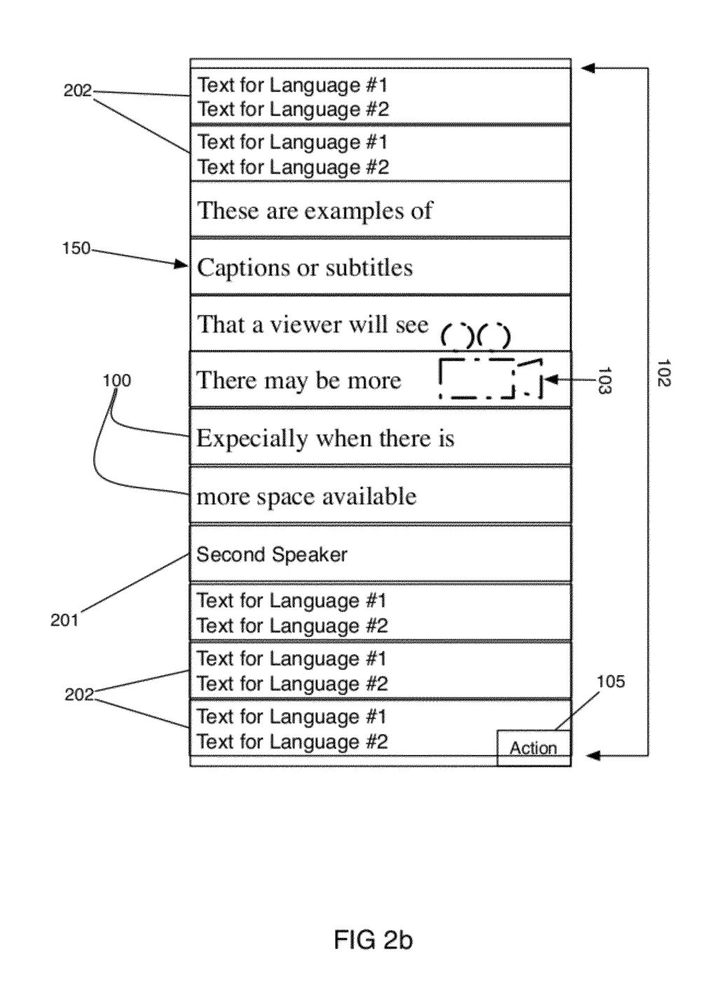

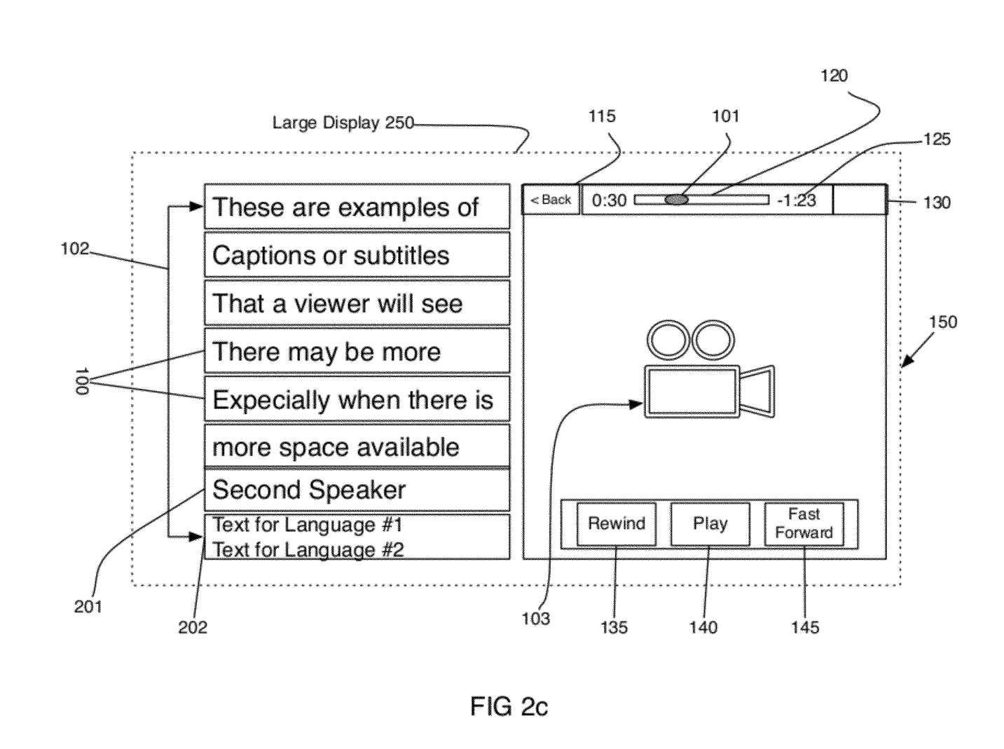

FIG. 2a shows a typical embodiment of the present invention's layout in portrait mode and media jump overlay (102) partial screen mode. Eight media jump links (100) are shown within the media jump overlay (102). The media jump links (100) within the media jump overlay (102) visually occupy the same space, or “overlay” the full motion media (103) displayed on the screen (150) of the conventional electronic device. In this case, we also show media jump links (100) configured to show a character context feature (201) that shows who is speaking (e.g., “First Speaker,” “Second Speaker,” etc.), and a multilingual feature (202) that enables a user to display text in different languages either singularly or simultaneously. The media player controls can be seen on both the top and bottom of the screen (150). On the top of the screen (150), there is a dismiss media button (110) by which the user can suspend the use of (i.e., close) the present invention, a media time progress bar (120) with a media time elapsed indicator (115), a media time slider (101), and a media time remaining indicator (125), and an option button (130). At the base of the screen are standard media controls, namely rewind (135), play (140), and fast forward (145). Also shown is an action button (105), which is designed to present a menu from which program options can be configured such as media selection, playback modes, visual preferences, and so forth.

FIG. 2b shows a typical embodiment of the present invention's layout in portrait mode with full screen media jump overlay (102). Twelve media jump links (100) are shown within the media jump overlay (102). The media jump links (100) within the media jump overlay (102) visually occupy the same space, or “overlay” the full motion media (103) displayed on the screen (150) of the conventional electronic device. Other features of the present invention shown in FIG. 2b include a multilingual feature (202) that enables a user to display text in different languages, and a character context feature (201) that shows who is speaking (e.g., “First Speaker,” “Second Speaker,” etc.). No media player controls are shown in FIG. 2b, excepting the action button (105) at the bottom of the screen (150). The action button (105) presents a menu from which program options can be configured such as media selection, playback modes, visual preferences, and so forth.

FIG. 2c shows a typical embodiment of the present invention's layout in large screen mode. Eight media jump links (100) are shown within the media jump overlay (102). The media jump links (100) within the media jump overlay (102) do not visually occupy the same space as the full motion media (103) displayed on the screen (150) of the conventional electronic device. Below the media jump links (100) are a character context feature (201) that shows who is speaking (e.g., “First Speaker,” “Second Speaker,” etc.), and a multilingual feature (202) that enables a user to display text in different languages. The media player controls can be seen on both the top and bottom of the screen (150). On the top of the screen (150), there is a dismiss media button (110) by which the user can suspend the use of (i.e., close) the present invention, a media time progress bar (120) with a media time elapsed indicator (115), a media time slider (101), and a media time remaining indicator (125), and an option button (130). At the base of the screen are standard media controls, namely rewind (135), play (140), and fast forward (145). During usage of the present invention, a user may resize the window to occupy a smaller portion of the actual physical screen (150). In this case, the media jump overlay (102) may no longer visually fit beside the full motion media (103), in which case we revert to an “overlay” of the media jump overlay (102) on top of the full motion media (103). This would in effect bring us back to operation of the present invention as described in FIG. 1a, 1b, 2a or 2b.

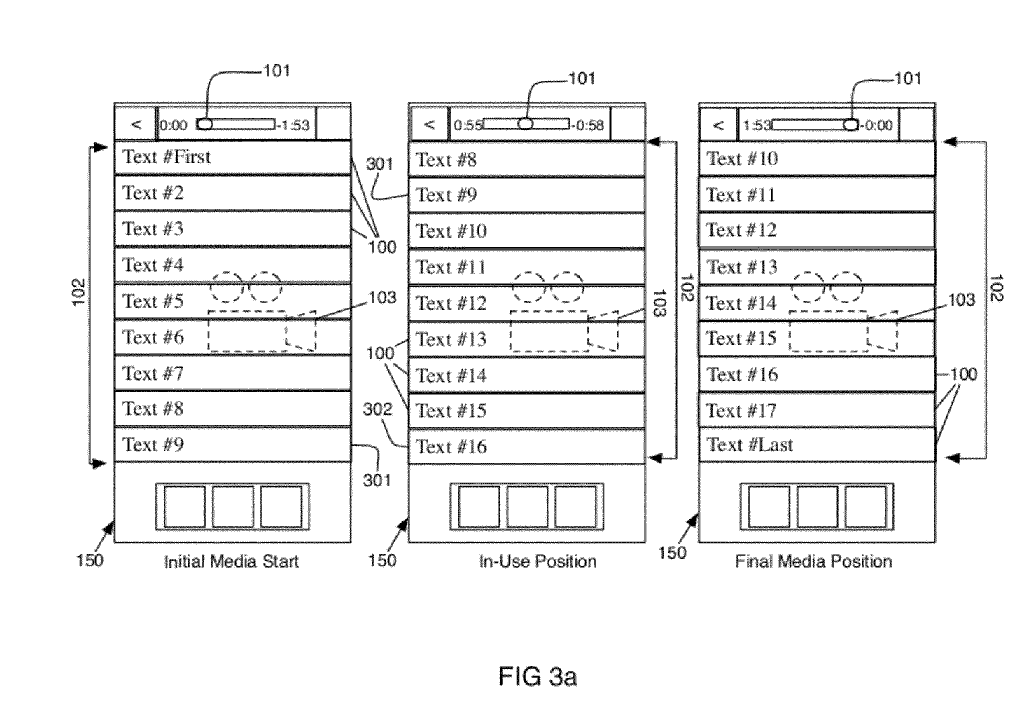

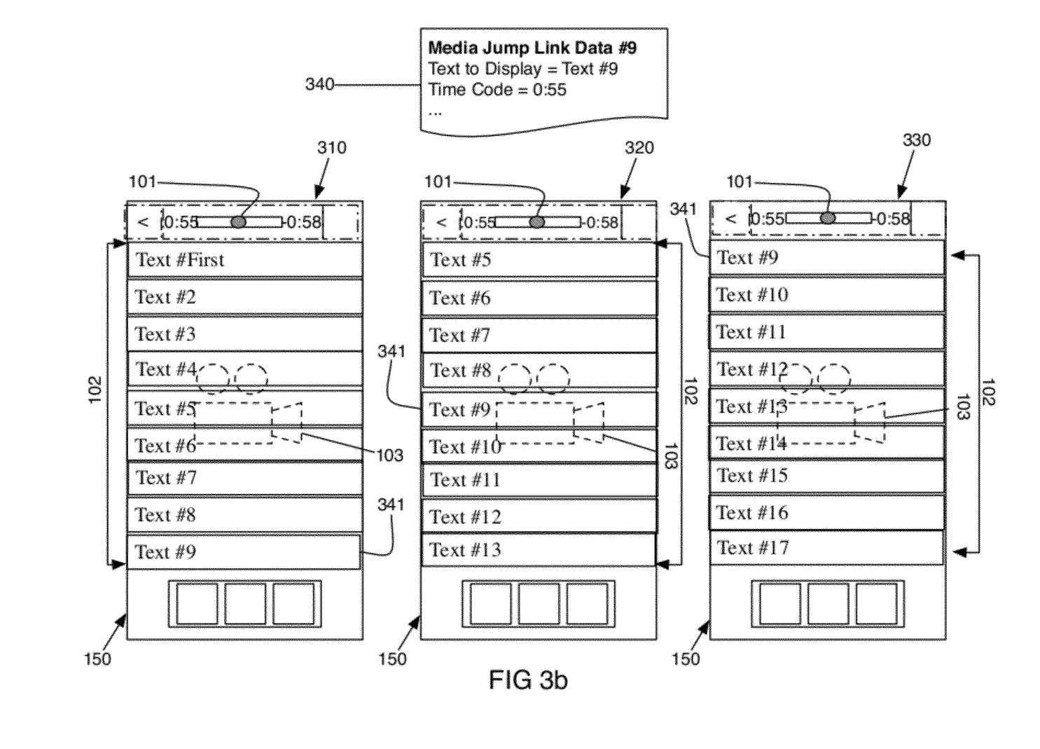

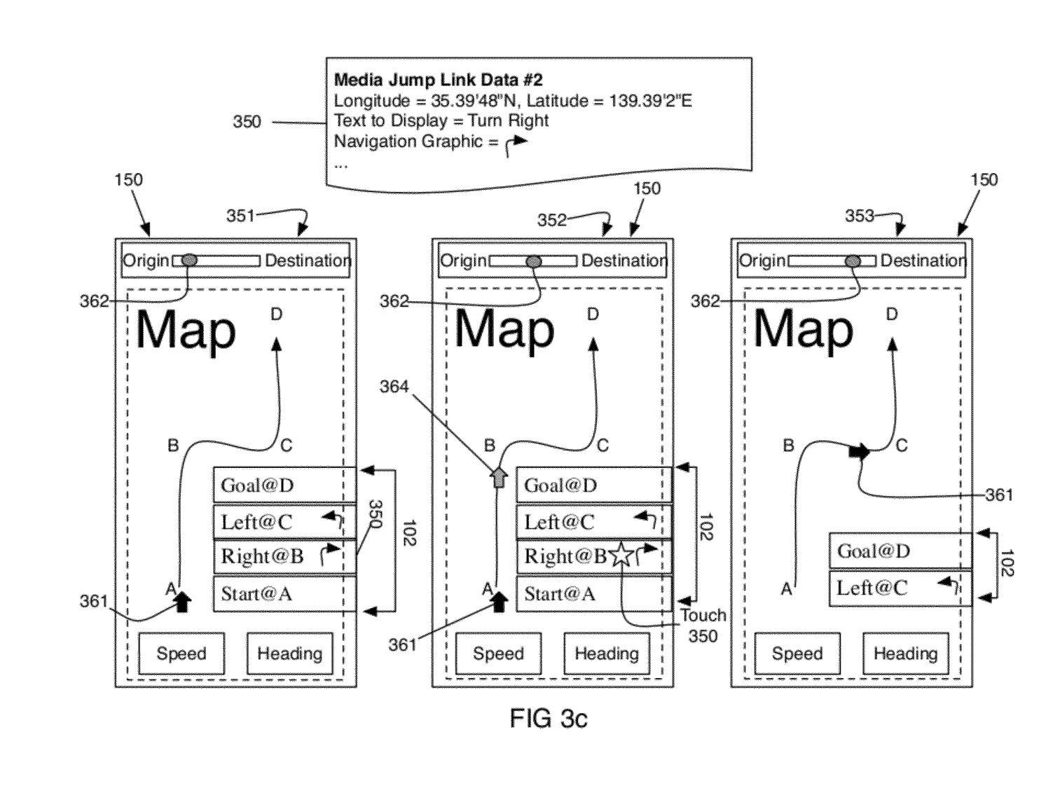

FIG. 3a shows how the media jump overlay (102) is synchronized with media playback, even during scrubbing. As media playback progresses, text captions on the media jump overlay (102) are synchronized to the media speech. If the media time slider (101) is dragged, the media jump overlay (102) scrolls to synchronize with the media speech. As media playback or navigation progresses, the lyrics, subtitles, or navigation elements continue to scroll. FIG. 3a shows the present invention in three positions, “Initial Media Start”, “In-Use Position”, and “Final Media Position”. In the “Initial Media Start” diagram in FIG. 3a, the media jump links (100) are shown superimposed over the full motion media (103) on a conventional screen (150). The media jump link labeled “Text #9” (301) is shown on the bottom of the screen (150). The “In-Use Position” diagram in FIG. 3a shows that when the media time slider (101) is dragged to cause the media to play from time 0:55, not only does the full motion media (103) move ahead but the media jump overlay (102) scrolls upwards as well, as shown by the “Text #9” (301) media jump link moving up to near the top of the screen (150), and renders the “Text #16” (302) media jump link at the bottom of the screen (150), which is the current media jump link for time 0:55. The “Final Media Position” diagram in FIG. 3a shows that the last media jump links (100) in the media jump overlay (102) are displayed on the screen (150) when the full motion media (103) has reached the end.

FIG. 3b shows how the media jump overlay (102) can be synchronized to render at any position on the screen (150). As media playback or navigation progresses, the lyrics, subtitles, or navigation elements continue to scroll, and the full motion media (103) and media jump overlay (102) can be synchronized to render at any position on the screen (150). This allows the actively spoken or sung audio media jump link (100) to be displayed at the bottom of the screen (150) as is traditionally done, or higher on the screen (150) to allow visual preview of upcoming elements. (In the case of navigation products such as GPS devices, the media jump overlay (102) synchronizes with the current navigation activity, as shown in FIG. 3c.) To illustrate, FIG. 3b uses the specific media jump link data element “Text #9” (341), which is assigned time code 0:55 as shown in “Media Jump Link Data #9” (340). The bottom of screen synchronization (310) diagram in FIG. 3b shows “Text #9” (341) rendered in bottom of screen synchronization (310), which places “Text #9” (341) and past phrases (or possibly future phrases if sorting order of media jump links was reversed) for view at the bottom of the media jump overlay (102). Or, as shown in the middle of the screen synchronization (320) diagram in FIG. 3b, “Text #9” (341) at time code 0:55 can be rendered in middle of the screen synchronization (320), which places “Text #9” (341) for view in the middle of the media jump overlay (102), future phrases below “Text #9” (341) and past phrases above “Text #9” (341). Middle of screen synchronization (320) is important in instructional videos where random visual access is more important than the exact timing of speech, such as in a cooking show where a user may want to view both performed actions and see what upcoming ingredients are necessary. Finally, as shown in the top of the screen synchronization (330) diagram in FIG. 3b, “Text #9” (341) at time code 0:55 can be rendered in top of the screen synchronization (330), which places “Text #9” (341) for view at the top of the media jump overlay (102) and future phrases below “Text #9” (341). If the user manually scrubs the video playback by navigating to a new chapter in the audio or video, or drags the video time slider (101) side to side, the media jump overlay (102) will continue to synchronize the active media jump link data element encoded with the current time in either bottom of the screen synchronization (310), middle of the screen synchronization (320), top of the screen synchronization (330), or the user can set the visual point of synchronization to another point on the media jump overlay (102).

FIG. 3c shows how the media jump overlay (102) is synchronized for navigation in a GPS system or its equivalent. To illustrate the navigation activities shown in FIG. 3c, a specific media jump link data element “Right@B” (350) (encoded as shown in FIG. 3c as “Media Jump Link Data #2”) is employed, which includes directional information like longitude, latitude, driving instructions, etc.

The first navigation function shown in FIG. 3c is the current location display function (351). Assuming we are navigating from starting point A through points B and C to destination point D, a typical navigation program will show on the screen (150) a current location icon (361) displaying the user's current location as well as a route progress marker (362). The media jump overlay (102), which includes “Right@B” (350), shows the directional information from starting point A to destination point D in text form, alongside the directional information from starting point A to destination point D in pictorial form.

The second navigation function shown in FIG. 3c is the navigation preview function (352). This function allows the user to interact with “Right@B” (350) within the media jump overlay (102). When the user touches “Right@B” (350), a preview location icon (364) appears within the navigation preview function (352) according to the directional information encoded into “Right@B” (350). Although this example of the navigation preview function (352) takes place while the user is still at the point of origin, “Right@B” (350) references a navigation action at point B, so the preview location icon (364) is shown at point B. The preview location icon (364) may have a different shape or color than the current location icon (361) to make it clear that the preview location icon (364) is not the present physical location. The route progress marker (362), which can be moved like a conventional media time slider, is another way the user can utilize the navigation preview function (352). After a pre-determined period of time, the navigation preview function (352) reverts back to the current location display function (351). Within the navigation preview function (352), the current location icon (361) may change in appearance to be a different shape or color to make it clear that this is not the actual current location being displayed.

A third navigation function shown in FIG. 3c is the immediate action display function (353). As the user's route navigation progresses, the current location icon (361) shows the user's location on the screen (150). The immediate action display function (353) also highlights the immediate navigation functions remaining to be performed by not displaying in the media jump overlay (102) navigation instructions that have already been performed. Only those navigation instructions that still remain to be performed by the user are displayed in the media jump overlay (102).

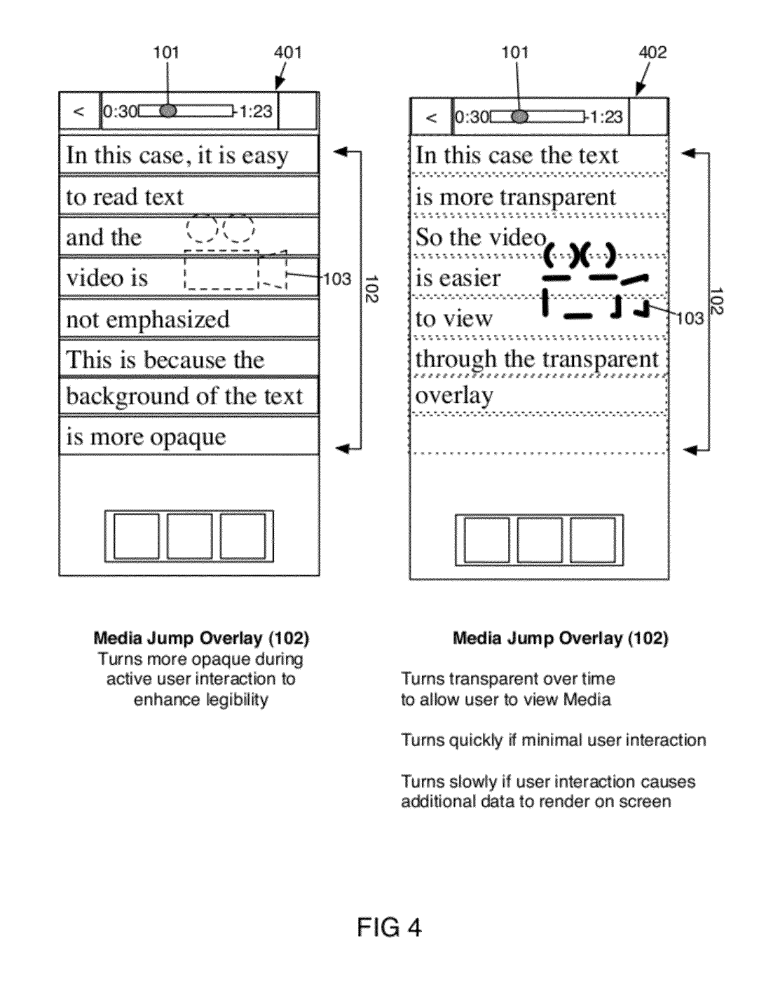

FIG. 4 shows how the media jump link (100) alpha and/or media jump overlay (102) alpha is adjusted depending on the amount and type of user interaction with the media jump overlay (102). (Alpha refers to the level of transparency that text has on a screen.) During playback, a user may use an input device (501) (whether finger, mouse, keyboard or other input device) to interact with the scrolling media jump overlay (102), resulting in the present invention determining whether to alter the alpha of any particular media jump link (100) or the entire media jump overlay (102), making it become a more opaque display (401) or a more transparent display (402).

With the more or fully opaque display (401) shown in FIG. 4, it is easy for the user to read the content in the media jump overlay (102) and the full motion media (103) is not emphasized, because the media jump link (100) or media jump overlay (102) is more opaque. The result is ultimately enhanced legibility of media jump links (100). With the more transparent display (402) shown in FIG. 4, the content of media jump links (100) and/or media jump overlay (102) is more transparent, so the full motion media (103) is easier to view through the transparent content. In addition, the media jump link (100) and/or media jump overlay (102) content turns transparent over time to allow the user to view the full motion media (103), turns transparent quickly if there is minimal user interaction, and turns transparent slowly if user interaction is significant (for example, if a certain amount of additional data is rendered onscreen). After interaction with the media jump overlay (102) ceases for a configurable amount of time, the media jump overlay (102) will immediately or gradually turn more and more transparent to a configurable amount. This means the media jump overlay (102) might always be visible to some degree, or if desired, simply disappear from view until requested. Additionally, the media jump overlay (102) may be activated, deactivated, repositioned or resized as desired by the user. This allows the user to view the media without subtitle or navigation distraction, until the media jump overlay (102) becomes the object of focus. This has the added benefit that this consumes no additional screen real estate, and allows for full-screen video or animation.

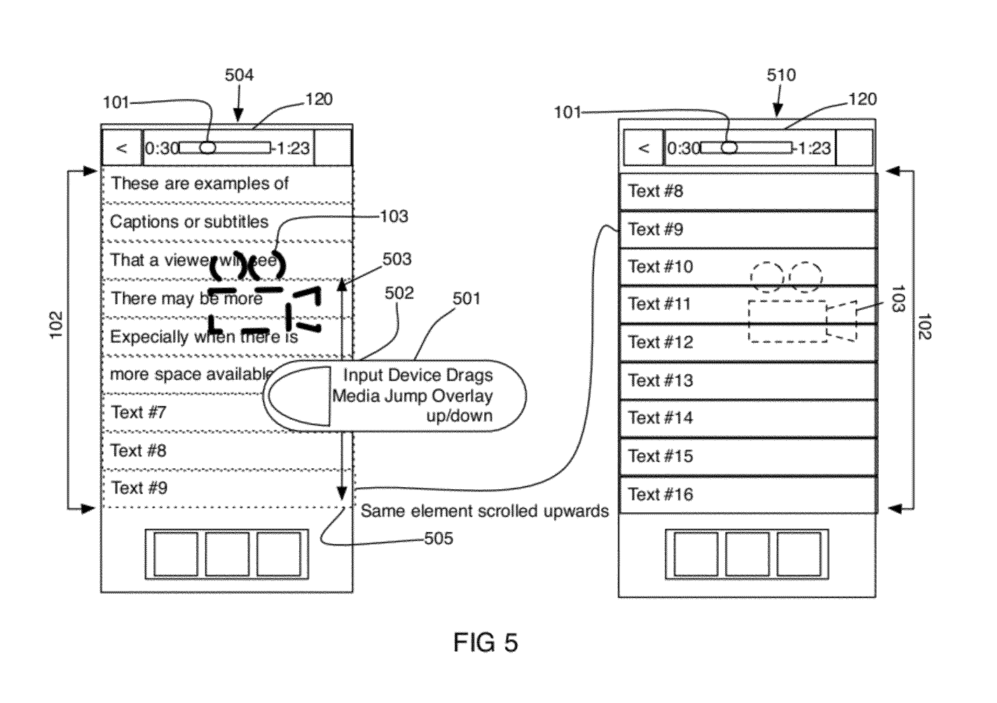

FIG. 5 shows how the media jump overlay (102) can scroll due to user interaction. However, when there is only dragging interaction, it does not immediately update the playback time of the full motion media (103) or the media time progress bar (120). As seen in FIG. 5, the first drag state diagram (504) shows the normal media playback with an input device (501) swiping the media jump overlay (102) upwards or downwards. During interaction of the media jump overlay (102) with the input device (501), the automatic synchronization of the media jump overlay (102) with the playback of the full motion media (103) can be disabled. This way, the computer is not automatically scrolling or synchronizing the media jump overlay (102) with the full motion media (103) while the user is trying to review past subtitles or preview upcoming ones. As shown in FIG. 5 in the first drag state diagram (504), an element (505) at position at the bottom of the display is dragged upwards towards the top of the display, as shown in the second drag state diagram (510). The element displayed at the bottom of the first drag state diagram (504) and near the top of the second drag state diagram (510) is the same element, only dragged to a different location on the display. However, the media playback time shown on the media time progress bar (120) in the first drag state diagram (504) is the same media playback time shown in the media time progress bar (120) of the second drag state diagram (510). In other words, a dragging action allows for review of previous media jump links (100), or preview of upcoming media jump links (100), without necessarily affecting the playback position of the full motion media (103).

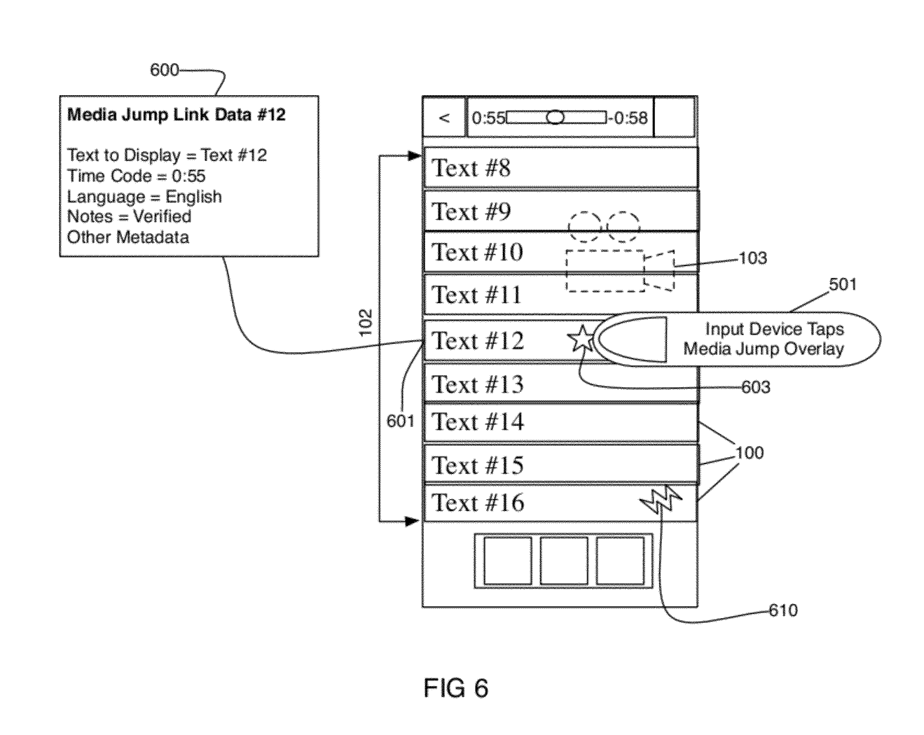

FIG. 6 shows how the media jump overlay (102) renders media jump links (100) based on media jump link data. It also shows what a brief tap or click interaction with a particular media jump link (100) will do based on a user's role. The user may select a particular visible media jump link (100), at which point the media will jump to the point in time associated with it. For example, selecting a previous sentence will make a sung or spoken phrase in the full motion media (103) be sung or spoken again. This is demonstrated in FIG. 6 by “Media Jump Link Data #12” (600) with its encoded data, which is rendered onscreen as a media jump link labeled “Text #12” (601). A tap is received on “Text #12” (601) from an input device (501), which fires off actions to “jump to a point in time” specified in the “Media Jump Link Data #12” (600) encoded data. For administrators, an optional administrative timing button (610) may be provided to facilitate synchronizing the current playback time for element timing based on the user's configuration and access rights. Of additional note is that the present invention will allow for human response time in its operation by synchronizing a user-configurable time earlier or later than the time selected by the user.

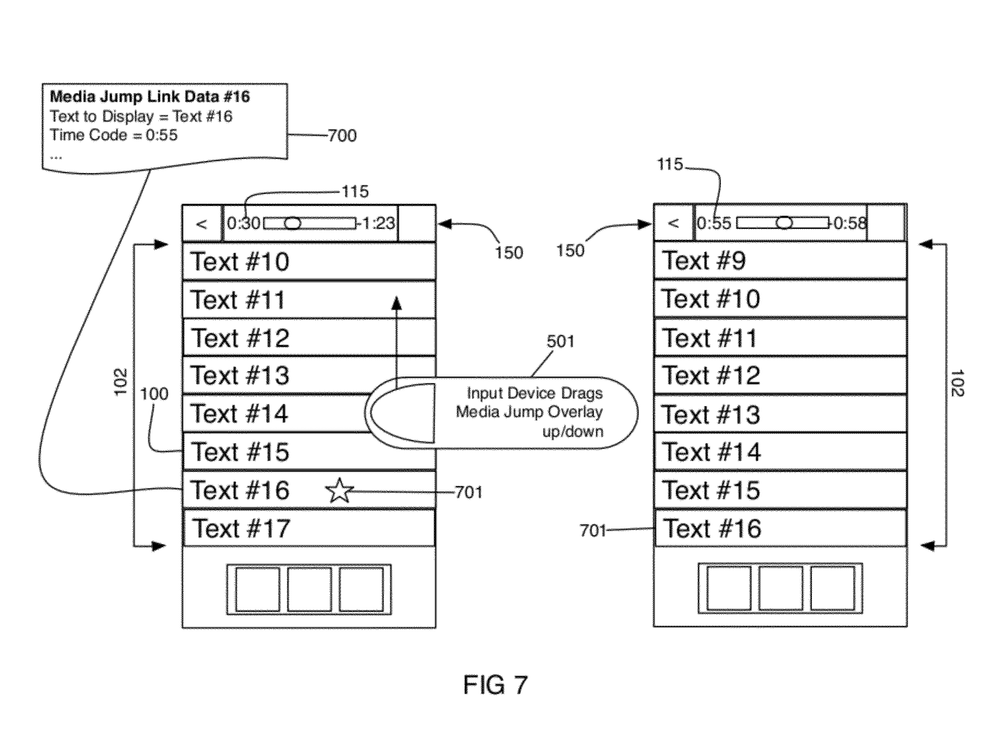

FIG. 7 shows how tapping or clicking a media jump link element can cause the playback position of the media to change. This is demonstrated in FIG. 7 by “Media Jump Link Data #16” (700) with its encoded data, which is rendered onscreen as a media jump link labeled “Text #16” (701). An input device (501) can drag “Text #16” (701) up to a higher or lower point on the screen (150). When the input device (501) then taps “Text #16” (701), the media time elapsed indicator (115), and the media playback associated with it, jumps from 0:30 to 0:55 as defined by the encoded data within “Media Jump Link Data #16” (700). “Text #16” (701) is then shown at the bottom of the screen (150), although its location can be synchronized anywhere on the screen the user chooses (as was shown above in FIG. 3b).

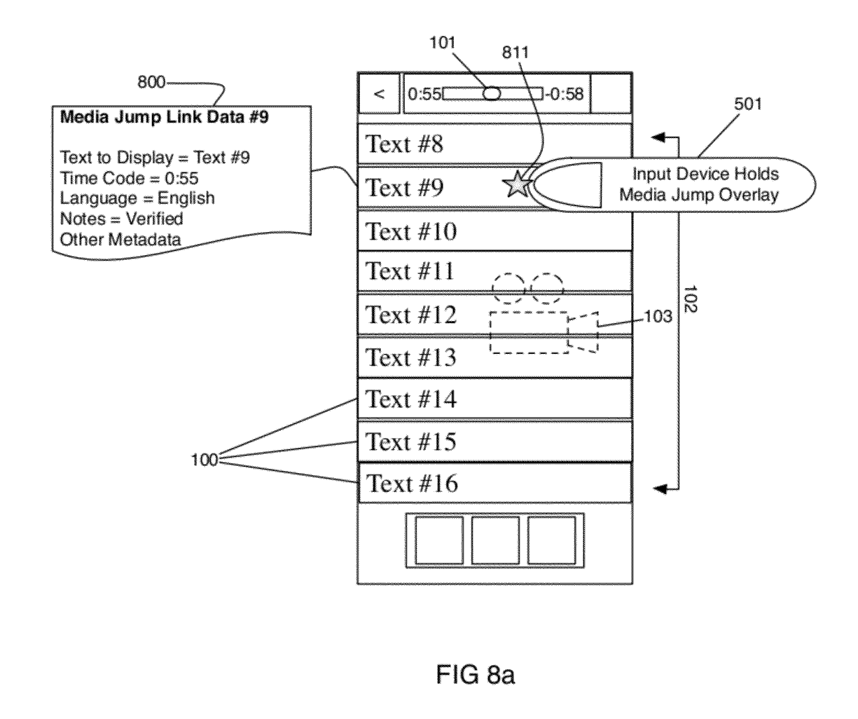

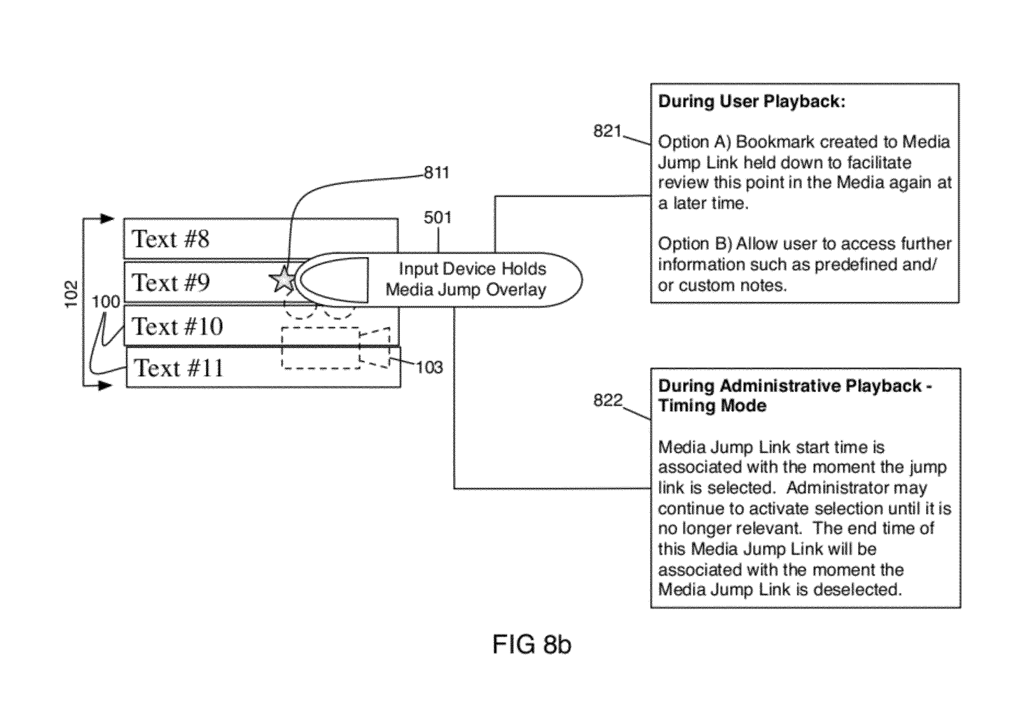

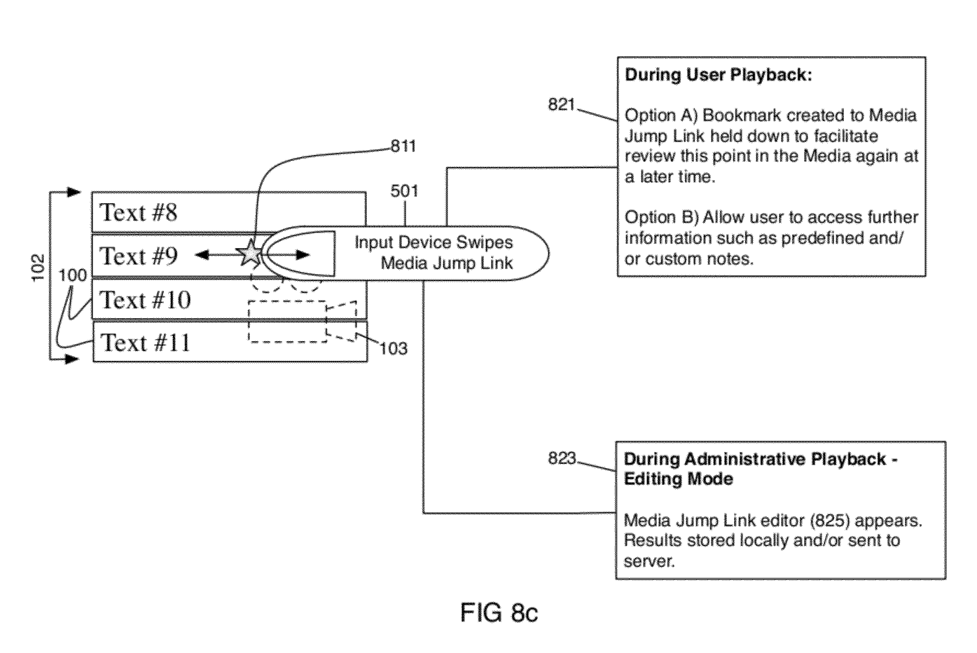

FIG. 8a shows how the media jump overlay (102) renders media jump links (100) based on media jump link data. Also, it shows what a hold interaction with a particular media jump link (100) will do based on a user's role. For example, if we render “Media Jump Link Data #9” (800) with its encoded data, which is rendered as a media jump link labeled “Text #9” (811), when the input device (501) touches or clicks, then holds down and does not immediately release “Text #9” (811), a series of actions based on the user's configuration and access level can be executed on the full motion media (103).

(Before proceeding on to FIG. 8b and FIG. 8c, it will be helpful to briefly explain the functions of timing mode (822) and editing mode (823). Timing mode (822) refers to the ability to update specific timing variables of a media jump link (100), specifically its “start time” and “end time”. When in timing mode (822), clicking, tapping or starting to hold down on a media jump link (100) simply takes the current playback time of the full motion media (103) being played and updates the start time of the media jump link (100) to reference that media time. When releasing a hold or click on a media jump link (100), we take the current playback time of the full motion media (103) being played and update the end time of the media jump link (100) to reference that media time. Editing mode (823) provides the ability to edit more than just the start and end times of the media jump link (100). It may edit start and end times, as well as text, graphics, speaker, language, dialect, mood, tags, and so forth without limitation so far as it relates to the data inside the media jump link.)

FIG. 8b shows how the media jump overlay (102) responds to a user's interaction with a particular media jump link (100). During user playback of the full motion media (103), when the input device (501) selects a particular media jump link such as “Text #9” (811), this opens up a playback options window (821) with options to make a bookmark, access further information, or a selected default action of the user's choice. (The options shown in the playback options window (821) are for the purpose of example, and can be configured differently by the user.) While in timing mode (822), when the input device (501) selects a particular media jump link such as “Text #9” (811), this will associate the start time for “Text #9” (811) with the moment on the full motion media (103) that “Text #9” (811) was selected. The end time of “Text #9” (811) will be associated with the moment on the full motion media (103) that “Text #9” (811) was deselected.

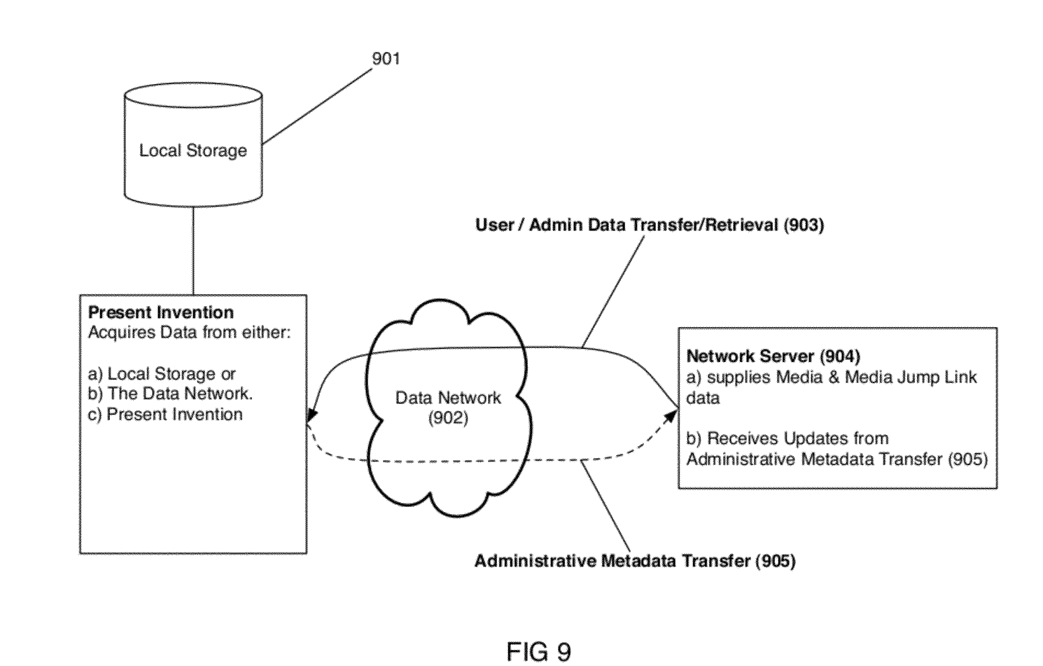

FIG. 8c illustrates how the media jump overlay (102) responds to a swipe interaction, i.e. when a user swipes a media jump link (100) to the left or right. During user playback of the full motion media (103), when the input device (501) swipes a particular media jump link, for example “Text #9” (811), this opens up a playback options window (821) with options to make a bookmark, access further information, or a default action of the user's choice. (The options shown in the playback options window (821) are for the purpose of example, and can be configured differently by the user.) During administrative playback, while in editing mode (823), when the input device (501) swipes a particular media jump link, for example “Text #9” (811), this will cause the media jump link editor (825) (not shown) to appear. The media jump link editor (825) will store the user's edits locally and/or send them to the network server (904) (shown in FIG. 9) when a network connection and bandwidth is available, and CPU cycles are also available, thus maintaining the “real-time” playback requirement of multimedia.

FIG. 9 diagrams how the present invention performs user/admin data transfer/retrieval (903) from local storage (901) or the data network (902), and sends administrative metadata transfers (905) back over the data network (902). The present invention can retrieve data from local storage (901), the data network (902), or even calculate such data based on user input (such as in a GPS navigation system where the series of events is calculated dynamically, perhaps even several times), and send administrative metadata transfers (905) back over the data network (902). The timing and editing results created by the present invention, which are termed administrative metadata, may be cached and stored in local storage (901) on the content creator's device, or uploaded over the data network (902) to a network server (904) via administrative metadata transfer (905).

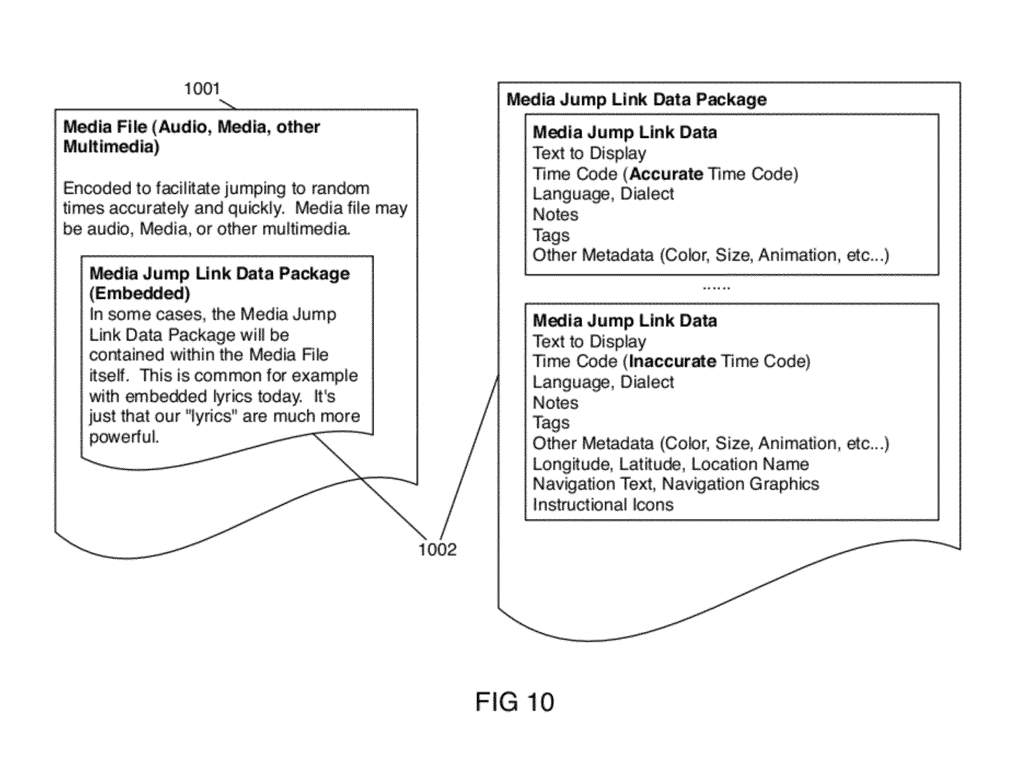

FIG. 10 shows an example of how data can be formatted to enable media jump links to jump to a time associated with a media file (1001). In order to facilitate viewing and delivery of the audio, video, and associated media jump links, a user may load a media file (1001) and a media jump link data package (1002) from local storage or over the data network from a network server (see FIG. 9) or via a data retrieval mechanism such as HTTP Download, FTP or some other custom protocol. Data such as the media file (1001) and media jump link data package (1002) may contain additional detail, such as language, dialect, subject matter, notes, time codes, arbitrary string tags, longitude, latitude, location name, navigation text, navigation graphics, instructional icons and so forth. The media jump link data package (1002) may be embedded within the media file (1001) for content distribution.

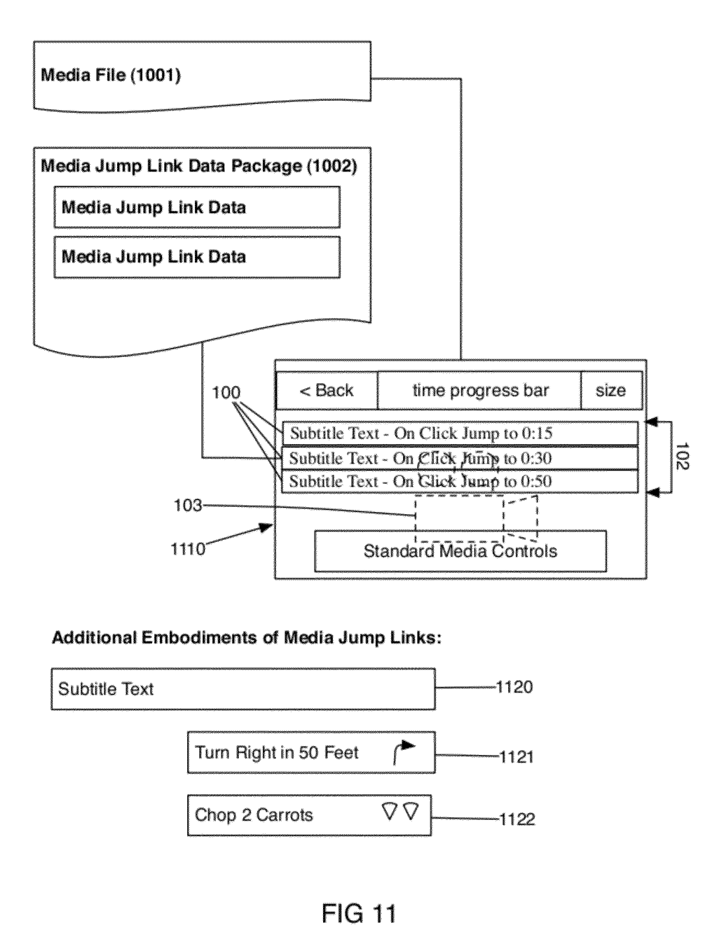

FIG. 11 shows how information is retrieved via local storage or via the network and rendered onscreen. In this case the media file (1001) will be rendered as onscreen video (1110), and the media jump link data package (1002), containing one or more media jump link data entries, is rendered on the media jump overlay (102) over the full motion media (103). Different embodiments of media jump links (100) are also shown in FIG. 11. There is shown a multimedia audio and video playback media jump link (1120) for use in a typical multimedia audio and video playback situation. There is also shown a text and visual navigation aid media jump link (1121) for use in a navigation program, with a narrower width so as to obscure less of the screen. For use in instructional videos such as cooking shows, there is shown a text and graphics media jump link (1122). Users casually browsing online or using a desktop PC may prefer to “stream” the data from a network server (see FIG. 9), allowing “on-demand” viewing of this product. However, mobile users may prefer to have all the information installed locally on the device itself to ensure accessibility even when the device is not on a network.

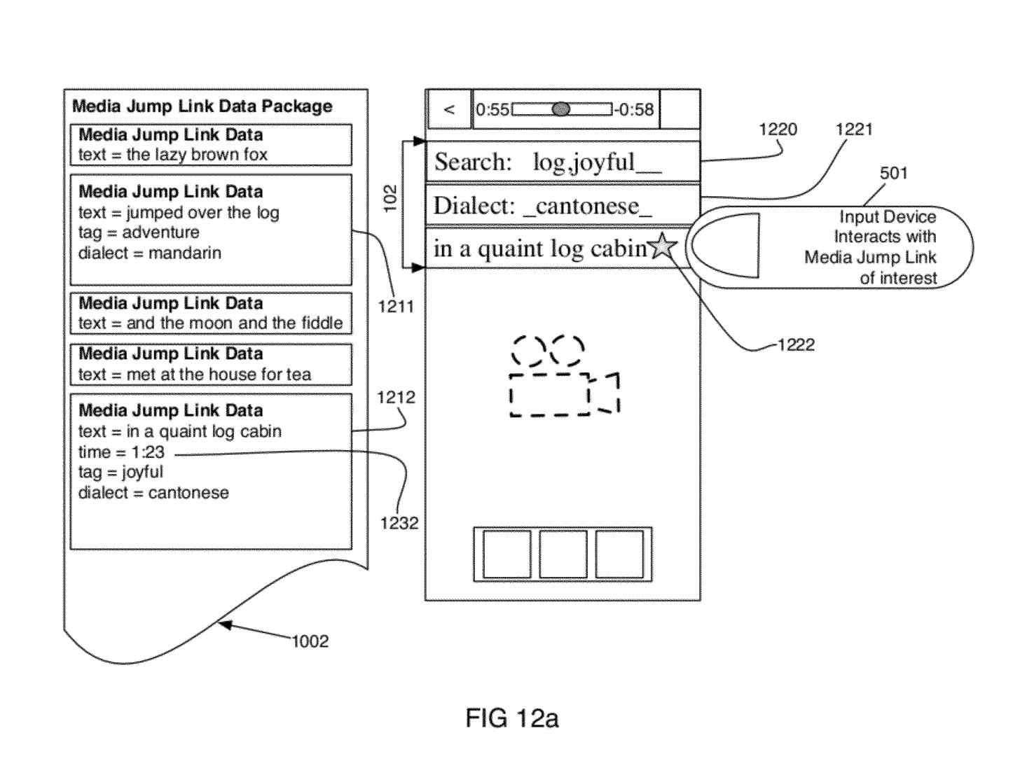

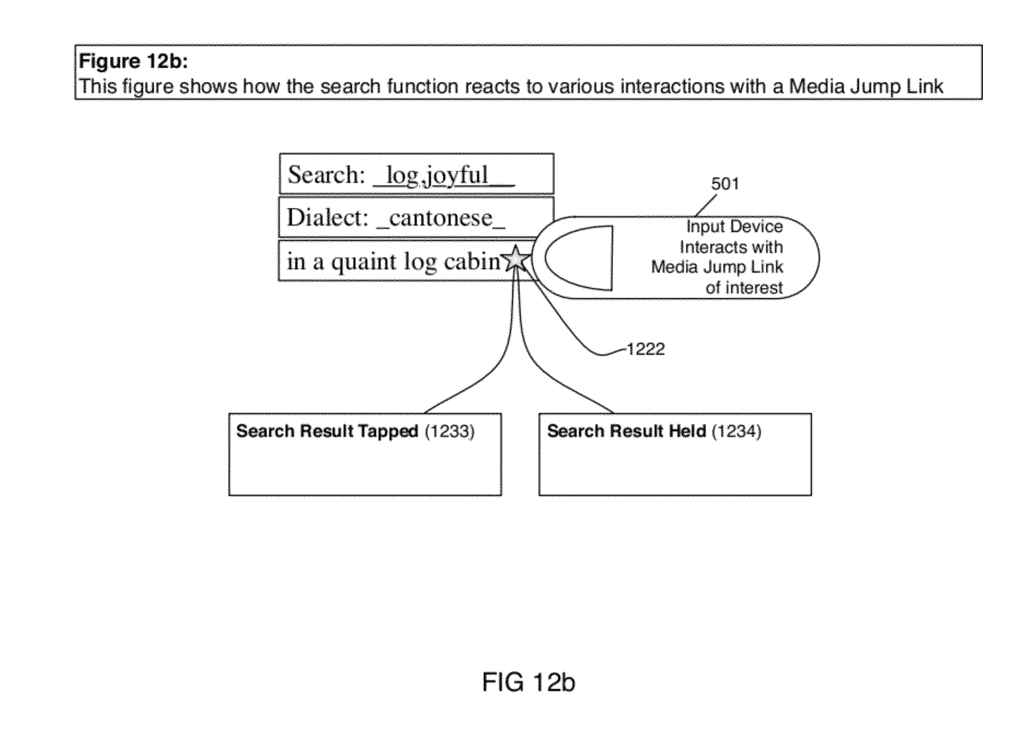

FIG. 12a shows how the search function enables quick navigation to media jump links of interest. When a media jump link the user wants to find is not quickly found, the user may invoke a search function to find the desired element. This is done by revealing the search term form (1220) and additional search term form (1221) at the top of the media jump overlay (102). The additional search term form (1221) may include common filters such as dialect, or even display checkboxes, radio buttons or selection menus to select speakers, emotion, subject matter and so forth. It is common for a quick jump to the top of the scrolling layer to be executed by touching the top of the display. As the user types the desired search term, the present invention can search through a configurable set of data for each media jump link data element. A button invoking search is not necessary. For example in FIG. 12a, within the media jump link data package (1002) are shown five media jump link data elements. Both the second media jump link data element (1211) and the fifth media jump link data element (1212) match the search string “log”. However, only the fifth media jump link data element (1212) has the proper tag of “joyful” and the dialect of “cantonese”. Thus only the fifth media jump link data element (1212) is rendered onscreen in the media jump link result form (1222). In addition, FIG. 12a shows that the user can utilize the input device (501) to select the media jump link result form (1222), which then reveals to the user the underlying fifth media jump link data element (1212) and its associated time (1232) (in this example, “1:23”).

FIG. 12b also shows how the search function reacts to various interactions with a media jump link. In this example, the input device (501) selects the media jump link result form (1222) (see FIG. 12a), which performs a function called search result tapped (1233). Search result tapped (1233) causes the media to jump to the time associated with the media jump link result form (1222), and the display returns to a normal, synchronized media jump overlay. When the input device (501) holds on the media jump link result form (1222), a function is performed called search result held (1234), which causes temporary playback of the media from the start time associated with the media jump link result form (1222) without actually jumping playback to that position. Upon release of the input device (501) from the media jump link result form (1222), playback is stopped.

It should be understood that all that which is described above is deemed novel and non-obvious, and that conventional programming knowledge for various platforms has been used to enable the above-mentioned present invention.

1. A method for creating and navigating links to multimedia, comprising:
a computer device playing media;
the computer displaying a media jump layer; and
the computer placing a media jump link, in the media jump layer.

2. The method of claim 1, wherein the media jump layer is a media jump overlay on top of the playing media.

3. The method of claim 1, further comprising visually modifying the media jump layer.

4. The method of claim 1, further comprising visually modifying the media jump link.

5. The method of claim 1, wherein said media jump link has a visual element.

6. The method of claim 1, wherein said media jump link corresponds to a point within the media.

7. The method of claim 1, further comprising assigning a time in said media to said media jump link.

8. The method of claim 1, wherein said media jump link is a text caption.

9. The method of claim 6, wherein said media jump link is synchronized with speech in the media.

10. The method of claim 3, wherein said visually modifying the media jump layer is chosen from the group: changing the opacity of the media jump layer; repositioning the media jump layer; resizing the media jump layer; making the media jump layer visible; making the media jump layer invisible.

11. The method of claim 4, wherein said visually modifying the media jump link is chosen from the group: changing the opacity of the media jump link; repositioning the media jump link; resizing the media jump link; making the media jump link visible; making the media jump link invisible.

12. The method of claim 1, further comprising interacting with the media jump link to change playback time of the media.

13. The method of claim 1, further comprising interacting with the media jump link to display information.

14. The method of claim 2, further comprising visually modifying the media jump layer.

15. The method of claim 2, further comprising visually modifying the media jump link.

16. The method of claim 3, further comprising visually modifying the media jump link.

17. The method of claim 2, wherein said media jump link has a visual element.

18. The method of claim 3, wherein said media jump link has a visual element.

19. The method of claim 4, wherein said media jump link has a visual element.

20. A method for creating and navigating links to multimedia, comprising:
a computer device playing media;
the computer displaying a media jump layer;
the computer placing a media jump link, in the media jump layer;
wherein the media jump layer is a media jump overlay on top of the playing media;
further comprising visually modifying the media jump layer;
further comprising visually modifying the media jump link;
wherein said media jump link has a visual element;
wherein said media jump link corresponds to a point within the media;
further comprising assigning a time in said media to said media jump link;
wherein said media jump link is a text caption;
wherein said media jump link is synchronized with speech in the media;
wherein said visually modifying the media jump layer is chosen from the group: changing the opacity of the media jump layer; repositioning the media jump layer; resizing the media jump layer; making the media jump layer visible; making the media jump layer invisible;
further comprising interacting with the media jump link to change playback time of the media;
further comprising interacting with the media jump link to display information; and
wherein said media jump link has a visual element.
